(19) United States
(12) Patent Application Publication
(10) Pub. No.: US 2008/0204696 A1
(43) Pub. Date: Aug. 28, 2008

(54) METHOD OF ALIGNMENT

(75) Inventor: Akifumi Kamijima, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK CORPORATION, Tokyo (JP)

(21) Appl. No.: 11/680,249

(22) Filed: Feb. 28, 2007

(51) Int. Cl. G03B 27/42

(52) U.S. Cl. 355/77

(57) ABSTRACT

The invention provides an alignment method for applying a one layer of shot exposure on and throughout a substrate, wherein a shot exposure area throughout the substrate is divided into N block areas Bᵢ (i=1 to N), each having multiple one-shot areas joined to one another in an adjoining state; N shot block correction measurement data P_{Bi} (i=1 to N) are found for each of the N block areas Bᵢ (i=1 to N); each of the N shot block correction measurement data P_{Bi} (i=1 to N) is fed back to an associated shot for the N block area Bᵢ (i=1 to N) to determine a ratio εᵢ (i=1 to N) of optical expansion and contraction of an exposure area for one shot per block; and at said ratio εᵢ (i=1 to N), all shots for each associated block are exposed to complete the one layer of shot exposure throughout the substrate, wherein said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas constituting said designated block Bᵢ (i=1 to N) and alignment marks in multiple shot areas adjoining to and encircling said designated block Bᵢ (i=1 to N). Thus, even when the expansion and contraction of the substrate based on temperature changes or stress changes is anisotropic throughout the substrate, the method of the invention can reliably follow the deformation of the substrate, making sure the optimum alignment operation with improved precision. It is also possible to satisfy the requirements for a fabrication process involving post-integration processing after the substrate is cut into multiple blocks.

### BACKGROUND OF THE INVENTION

1. Field of the Invention

The present invention relates to an alignment method for the projection alignment, using an aligner, of pattern images at fabrication process steps of thin-film magnetic heads, semiconductor devices, liquid crystal display devices or the like.

2. Explanation of the Prior Art

For instance, a silicon substrate for semiconductors has a single-crystal structure; it is substantially uniform in its entirety. For this reason, even when, in the fabrication process of a semiconductor device using a silicon substrate, the substrate is expanded or contracted by temperature changes at the time of heating, cooling or the like as well as stress changes (addition of compression stress and shrinkage stress) in various films stacked together for device formation, it is general that such changes often take place isotropically throughout the substrate.

On such a silicon substrate for semiconductors, there are ordinarily thousands or tens of thousands of devices of multilayer structure formed. To this end, multiple shots are carried out on the silicon substrate using an aligner (stepper, scanner or the like), completing shot exposure of one layer forming devices throughout the substrate. At one-shot area for one shot exposure, for instance, there are several hundred devices formed in alignment, and the one-shot area includes a pair of alignment marks indicative of position information in the X and Y directions. The shot exposure for one layer of devices throughout the substrate is implemented until multiple layers for device formation are obtained. In that case, there is the need for alignment operation where shot alignment is made in consideration of the previous shot pattern already formed.

For that reason, in order to bring the underlying layer that is the already formed previous shot pattern in alignment with the layer being now exposed, there is first an operation carried out for sorting several shot areas out of such an underlying layer as shown in typically in FIG. 4 uniformly and at a constant ratio all over the substrate. Suppose here that multiple shot areas indicated by Nos. 6, 9, 12, 14, 17, 20, 23, 25, 28 and 31 in the drawing are selected out. Then, the respective alignment marks in those shot areas are used to measure and figure out the expansion and contraction of the substrate. Correction measurement data for the shot block, obtained at a result of calculation, are used as average correction data Pₐᵥ for the whole substrate to reflect the data Pₐᵥ on all shots (shot Nos. 1-36), thereby determining the ratio of optical expansion and contraction of an exposure area for one shot. Then, all shots are exposed at this ratio to complete the one layer of shot exposure throughout the substrate. As noted above, even when a silicon substrate for semiconductors is subjected to expansion and contraction in its fabrication process, its expansion and contraction, for the most part, is generally isotropic. Accordingly, even when one single expansion-and-contraction data (correction data Pₐᵥ) figured out as the average value for the whole substrate is used directly as the expansion-and-contraction information for the whole substrate to reflect it on individual shots, there would be no or little problem.

Among substrates, however, there is a so-called sintered substrate obtained by compression molding and then sintering fine particles of inorganic materials such as AlTiC used for the fabrication process of, e.g., thin-film magnetic heads. Such a sintered substrate suffers from expansion and contraction by temperature changes due to heating, cooling or the like as well as stress changes or the like in various films stacked together for device formation: the expansion and contraction of that substrate is generally anisotropic, and so differ largely from area to area. In other words, when one single expansion-and-contraction data found as the average value for the whole substrate is used as the expansion-and-contraction information for the whole substrate and reflected on individual shots, it is highly likely that some areas are in proper alignment, but some are in improper alignment.

Generally in the fabrication process of thin-film magnetic heads, a substrate is cut into multiple blocks for post-integration processing: there is alignment precision for each block desired rather than average alignment precision for the whole substrate.

The situations being like this, the present invention has for its object the provision of an alignment method that can follow expansion and contraction changes of a substrate, even when the expansion and contraction of that substrate based on temperature changes or stress changes are anisotropic throughout the substrate, making sure optimum alignment operation. The invention also provides an alignment method that can also satisfy the requirements for post-integration processing after the substrate is cut into multiple blocks.

### SUMMARY OF THE INVENTION

To provide a solution to such problems as mentioned above, the present invention provides an alignment method for applying a one layer of shot exposure on and throughout a substrate, wherein:

a shot exposure area throughout the substrate is divided into N block areas Bᵢ (i=1 to N), each having multiple one-shot areas joined to one another in an adjoining state,

N shot block correction measurement data P_{Bi} (i=1 to N) are found for each of the N block areas Bᵢ (i=1 to N),

each of the N shot block correction measurement data P_{Bi} (i=1 to N) is fed back to an associated shot for the N block area Bᵢ (i=1 to N) to determine a ratio εᵢ (i=1 to N) of optical expansion and contraction of an exposure area for one shot per block, and

at said ratio εᵢ (i=1 to N), all shots for each associated block are exposed to complete the one layer of shot exposure throughout the substrate, wherein:

said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas constituting said designated block Bᵢ (i=1 to N) and alignment marks in multiple shot areas adjoining to and encircling said designated block Bᵢ (i=1 to N).

In a preferable embodiment of the alignment method according to the invention, said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas constituting said designated block Bᵢ (i=1 to N).

In another preferable embodiment of the alignment method according to the invention, said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas adjoining to and encircling said designated block.

In yet another preferable embodiment of the alignment method according to the invention, when said shot block correction measurement data are found, the number of the shot areas to be selected is at least 2 with respect to the total of shot areas in the designated block.

In a further preferable embodiment of the alignment method according to the invention, said one-shot area is an area exposed in one single exposure operation.

In a further preferable embodiment of the alignment method according to the invention, said substrate is a sintered substrate obtained by compression molding and then sintering fine particles of an inorganic material.

In a further preferable embodiment of the alignment method according to the invention, said substrate is a semiconductor substrate.

### BRIEF DESCRIPTION OF THE DRAWINGS

FIG. 1 is illustrative of the alignment method according to the invention; it is a plan view with 1 to 36 shot exposures corresponding to one layer drawn on a substrate.

FIG. 2 is a plan view illustrative of how to specifically check alignment precision in one embodiment of the invention, in which all shots corresponding to one layer in FIG. 1 are drawn on an enlarged scale.

FIGS. 3A, 3B and 3C are illustrative of specific offsets for checking alignment precision; FIG. 3A is a plan view illustrative of relations of an alignment measurement mask to a resist specifically formed by exposure on that mark to check an offset, FIG. 3B is a view as taken on direction A-A in FIG. 3A, and FIG. 3C is a view as taken on direction B-B in FIG. 3A.

FIG. 4 is illustrative of one exemplary prior method; it is a plan view with 1 to 36 shot exposures corresponding to one layer drawn on a substrate.

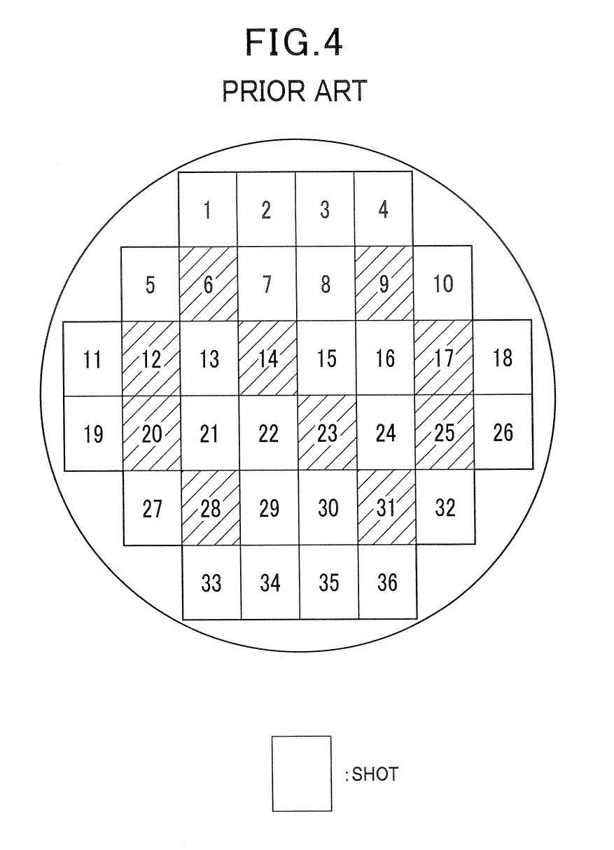

### DETAILED EXPLANATION OF THE INVENTION

The alignment method of the invention is now explained in great detail.

The alignment method of the invention is to apply a one layer of shot exposure on and throughout a substrate. For instance, the alignment method of the invention is to align an underlying layer that is the already formed previous shot pattern with a layer to which shot exposure is now applied.

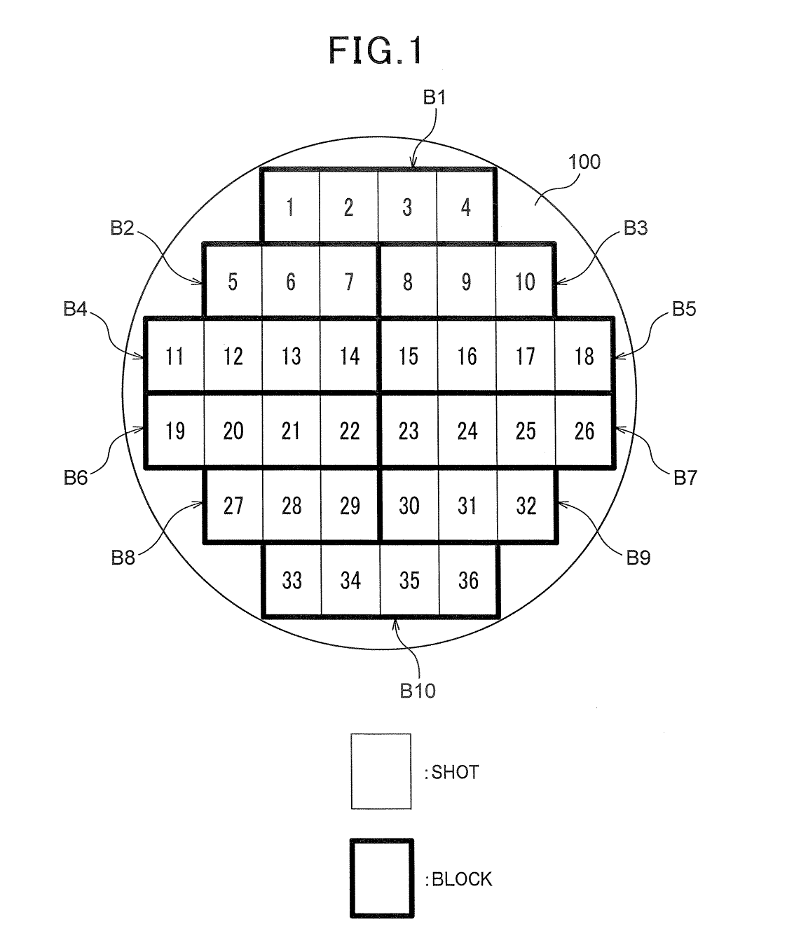

FIG. 1 is a plan view illustrative of one exemplary alignment method according to the invention, with shot areas 1-36 corresponding to one layer drawn on a substrate 100.

The substrate 100 used here, for instance, includes a silicon substrate for semiconductors, and a sintered substrate obtained by compression molding and then sintering fine particles of an inorganic material such as AlTiC used for the fabrication process of thin-film magnetic heads.

The alignment method of the invention works more favorably for the substrate 100 subjected to generally anisotropic expansion or contraction by temperature changes caused by heating, cooling, etc. in the fabrication process of various devices as well as stress changes (addition of compression stress and shrinkage stress) in various films stacked together for device formation.

One example of the substrate 100 of the anisotropic type is a sintered substrate such as AlTiC, as noted above. The invention may also be applied to even a substrate that is of the isotropic type yet susceptible of anisotropic expansion and contraction caused by process factors. It should be noted, however, that the alignment method of the invention may just as well be applied to the substrate 100 that suffers from an isotropic change throughout it (e.g., a silicon substrate for semiconductors), because there is alignment precision well maintained.

Referring here to shot exposures for one layer throughout the substrate 100, for instance, all shot exposures are implemented throughout the substrate while each shot is in alignment and superposition with each shot of the underlying layer that is the already formed previous shot pattern. One layer corresponds to a sum of individual shot areas 1-36 shown in FIG. 1, and the underlying layer is the already formed pattern, out of which the substrate itself is eliminated. This is because when shot exposures for the first one layer are implemented, the individual shots are in alignment with the substrate and exposure (the 1^{st} exposure) is carried out at the mechanical and optical precision that the aligner involved has. In other words, alignment operation using an alignment mark is not effected at the 1^{st} exposure.

In the alignment method of the invention, shot exposure areas throughout the substrate 100 (corresponding to the total sum of individual shot areas 1-36 shown in FIG. 1) are broken down into N block areas Bᵢ (i=1 to N) each having multiple one-shot areas lying one adjacent to another in a bar form. The N block areas Bᵢ in a bar form could be one unit for dividing the substrate into multiple blocks for post-integration processing in the fabrication process of, e.g., thin-film magnetic heads; that is, alignment precision for each block is more desired rather than the average alignment precision for the whole substrate.

The number, N, of block areas here is supposed to be N=10 for simplification of explanation; however, N is usually about 4 to 20, and the number of shots in one block is usually about 2 to 5. Within one shot, usually, there are about 300 to 1,500 identical device patterns formed.

In FIG. 1, an area marked off by thick lines is indicative of a block area, in which shot areas marked off by fine lines are located. It should be noted that one shot area (one-shot area) is one that is exposed in one exposure operation (shot).

In FIG. 1, ten blocks are illustrated (N=10), and shot exposure areas are formed by ten block areas B1 to B10 throughout the substrate 100.

As shown in FIG. 1,

the block area B1 is built up of a set of shot areas 1-4;

the block area B2 is built up of a set of shot areas 5-7;

the block area B3 is built up of a set of shot areas 8-10;

the block area B4 is built up of a set of shot areas 11-14;

the block area B5 is built up of a set of shot areas 15-18;

the block area B6 is built up of a set of shot areas 19-22;

the block area B7 is built up of a set of shot areas 23-26;

the block area B8 is built up of a set of shot areas 27-29;

the block area B9 is built up of a set of shot areas 30-32; and

the block area B10 is built up of a set of shot areas 33-36.

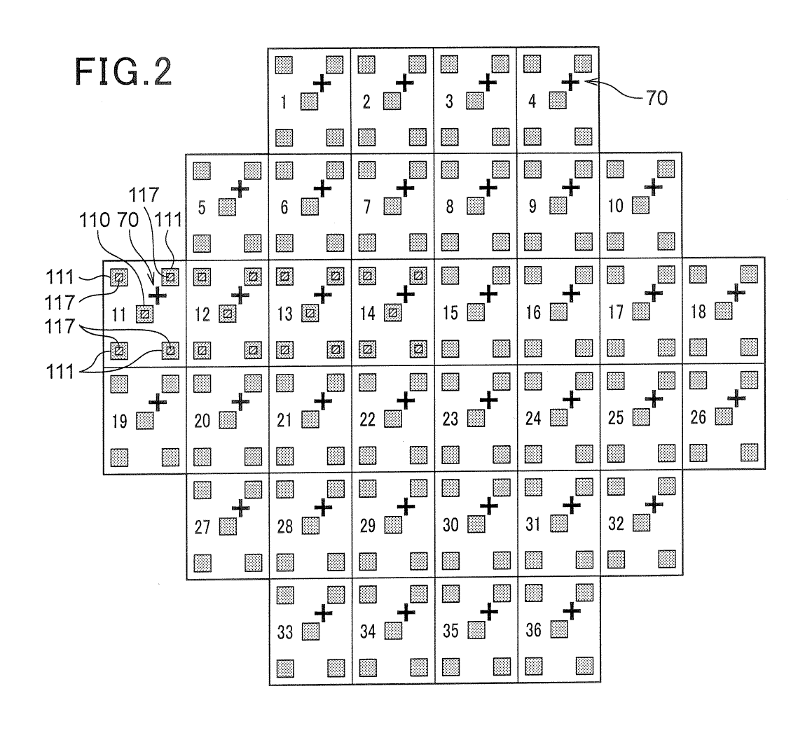

It should be noted that in each shot area 1-36, there is one alignment mark. This alignment mark, for instance, may be a so-called crisscross mark defined by a pair of lines in the X and Y directions per one shot. For that alignment mark, such a crisscross mark 70 as shown in FIG. 2 may be mentioned as one example.

In the embodiment here, there are 10 shot block correction measurement data P_{B1} to P_{B10} found corresponding to the ten block areas B1 to B10, respectively (for instance, shot block correction measurement data P_{Bi} (i=1 to N) for the block Bᵢ). And then, each of the ten shot block correction measurement data P_{B1} to P_{B10} is fed back to each of the associated N block areas B1 to B10 to determine the ratio εᵢ (i=1 to 10) of optical expansion and contraction of the exposure area corresponding to one shot for each block B1 to B10. Then, all shots for each block B1 to B10 are exposed in order at that rate εᵢ (i=1 to 10) to complete the one layer of shot exposure throughout the substrate. It should be noted that the state of expansion and contraction of the substrate is learned on the basis of the shot block correction measurement data P_{Bi}, and the operation all the way to feeding back the data P_{Bi} to determine the ratio εᵢ of optical expansion and contraction of the exposure area for one shot may be carried out according to the known operational processing method.

The shot block correction measurement data P_{B1} to P_{B10} that are part of the invention are found in the following way.

For the sake of an easy understanding, how to find the shot block correction measurement data P_{B4} corresponding to the block B4 shown in FIG. 1 is explained as an example.

### (Regarding the Block B4)

In the example here, the designated block to be designated for shotting is the block B4. The designated block B4 is built up of shot areas 11, 12, 13 and 14. The shot areas adjoining to and encircling the designated block B4 are multiple shot areas 5, 6, 7, 8, 15, 19, 20, 21, 22 and 23.

And then, multiple alignment marks selected from those in the multiple shot areas 11, 12, 13 and 14 that constitute the designated block B4 and those in the multiple shot areas 5, 6, 7, 8, 15, 19, 20, 21, 22 and 23 adjoining to and encircling that designated block B4 are used to measure and figure out the expansion and contraction of the substrate, thereby obtaining the shot block correction measurement data P_{B4} corresponding to the block B4. It should be noted that shot areas in point contact with the corners of the ends of the designated block, too, are included in the “multiple shot areas adjoining to and encircling the designated block”. For instance, such shot areas correspond to the shot areas 8 and 23 at the designated block B4.

For instance the multiple alignment marks are selected regarding the designated block B4 as in the following examples (1) to (6).

(1) Selection is made from only the four shot areas 11, 12, 13 and 14 that constitute the designated block B4: all alignment marks in them are used (a total of 4).

(2) Selection is made from only the four shot areas 11, 12, 13 and 14 that constitute the designated block B4, but alignment marks in three shot areas 11, 13 and 14 (a total of 3).

(3) The alignment marks in seven shot areas 5, 6, 7, 19, 20, 21 and 22 out of the multiple shot areas 5, 6, 7, 8, 15, 19, 20, 21, 22 and 23 adjoining to and encircling the designated block B4 (a total of 7).

(4) The alignment marks in five shot areas 5, 7, 19, 21 and 22 out of the multiple shot areas 5, 6, 7, 8, 15, 19, 20, 21 and 22 and 23 adjoining to and encircling the designated block B4 (a total of 5).

(5) A total of 8 alignment marks are used: all alignment marks in the four shot areas 11, 12, 13 and 14 that constitute the designated block B4, and four alignment marks in four shot areas 5, 7, 19 and 21 selected from the multiple shot areas 5, 6, 7, 8, 15, 19, 20, 21, 22 and 23 adjoining to and encircling the designated block B4.

(6) A total of 4 alignment marks are used: alignment marks in two shot areas 12 and 14 selected from the four shot areas 11, 12, 13 and 14 that constitute the designated block B4, and two alignment marks in two shot areas 6 and 21 selected from the multiple shot areas 5, 6, 7, 8, 15, 19, 20, 21, 22 and 23 adjoining to and encircling the designated block 34.

While these are preferable examples, it is understood that the invention is not limited to them; obviously, other examples of selection could be used, too.

The thus selected multiple alignment marks are used to measure and figure out the expansion and contraction of the substrate thereby obtaining the shot block correction measurement data P_{B4} corresponding to the block B4. The obtained shot block correction measurement data P_{B4} are fed back to the shots of the shot areas 11, 12, 13 and 14 that constitute the associated block area B4, respectively, to determine the rate ε₄ of optical expansion and contraction of the exposure area for one shot. At that rate ε₄, all the shots in the block area B4 are exposed to complete the shot exposure for the block area B4.

It should be noted that when the shot block correction measurement data P_{B4} are figured out, the number of the shot areas to be selected is at least two relative to a total of 4 shot areas in the designated block B4. As this number is below 2, there is not much of correction, rendering it impossible to achieve the demanded alignment correction. This ratio is necessary for other blocks, too.

For each of the blocks other than the block B4, too, the same method is used to complete the shot exposure for the associated block area. At the time when all shot exposures for the blocks B1 to B10 are over, the one layer of shot exposure throughout the substrate is completed.

Just to be sure, a brief account is now given of each of the blocks other than the aforesaid block B4, too.

### (Regarding the Block B1)

The designated block B1 is built up of shot areas 1, 2, 3 and 4. Shot areas adjoining to and encircling the designated block B1 are multiple shot areas 5, 6, 7, 8, 9, and 10.

Multiple alignment marks selected from those in the multiple shot areas 1, 2, 3 and 4 that constitute the designated block B1 and those in the multiple shot areas 5, 6, 7, 8, 9 and 10 adjoining to and encircling that designated block B1 are used to measure and figure out the expansion and contraction of the substrate, so that shot block correction measurement data P_{B1} corresponding to the block B1 are obtained.

The obtained shot block correction measurement data P_{B1} are fed back to the shots for the shot areas 1, 2, 3 and 4 that constitute the associated block area B1, respectively, to determine the ratio ε₁ of optical expansion and contraction of a one shot of exposure area. At that ratio ε₁, all the shots in the block area B1 are exposed to complete the shot exposure for the block area B1.

### (Regarding the Block B2)

The designated block B2 is built up of shot areas 5, 6 and 7. Shot areas adjoining to and encircling the designated block B2 are multiple shot areas 1, 2, 3, 8, 11, 12, 13, 14 and 15.

Multiple alignment marks selected from those in the multiple shot areas 5, 6 and 7 that constitute the designated block B2 and those in the multiple shot areas 1, 2, 3, 8, 11, 12, 13, 14 and 15 adjoining to and encircling that designated block B2 are used to measure and figure out the expansion and contraction of the substrate, so that shot block correction measurement data P_{B2} corresponding to the block B2 are obtained.

The obtained shot block correction measurement data P_{B2} are fed back to the shots for the shot areas 5, 6 and 7 that constitute the associated block area B2, respectively, to determine the ratio ε₂ of optical expansion and contraction of a one shot of exposure area. At that ratio ε₂, all the shots in the block area B2 are exposed to complete the shot exposure for the block area B2.

### (Regarding the Block B3)

The designated block B3 is built up of shot areas 8, 9 and 10. Shot areas adjoining to and encircling the designated block B3 are multiple shot areas 2, 3, 4, 7, 14, 15, 16, 17 and 18.

Multiple alignment marks selected from those in the multiple shot areas 8, 9 and 10 that constitute the designated block B3 and those in the multiple shot areas 2, 3, 4, 7, 14, 15, 16, 17 and 18 adjoining to and encircling that designated block B3 are used to measure and figure out the expansion and contraction of the substrate, so that shot block correction measurement data P_{B3} corresponding to the block B3 are obtained.

The obtained shot block correction measurement data P_{B3} are fed back to the shots for the shot areas 8, 9 and 10 that constitute the associated block area B3, respectively, to determine the ratio ε³ of optical expansion and contraction of a one shot of exposure area. At that: ratio ε₃, all the shots in the block area B3 are exposed to complete the shot exposure for the block area B3.

### (Regarding the Block B5)

The designated block B5 is built up of shot areas 15, 16, 17 and 18. Shot areas adjoining to and encircling the designated block B5 are multiple shot areas 7, 8, 9, 10, 14, 22, 23, 24, 25 and 26.

Multiple alignment marks selected from those in the multiple shot areas 15, 16, 17 and 18 that constitute the designated block B5 and those in the multiple shot areas 7, 8, 9, 10, 14, 22, 23, 24, 25 and 26 adjoining to and encircling that designated block B5 are used to measure and figure out the expansion and contraction of the substrate, so that shot block correction measurement data P_{B5} corresponding to the block B5 are obtained.

The obtained shot block correction measurement data P_{B5} are fed back to the shots for the shot areas 15, 16, 17 and 18 that constitute the associated block area B5, respectively, to determine the ratio E5 of optical expansion and contraction of a one shot of exposure area.

At that ratio ε₅, all the shots in the block area B5 are exposed to complete the shot exposure for the block area B5.

### (Regarding the Block B6)

The designated block B6 is built up of shot areas 19, 20, 21 and 22. Shot areas adjoining to and encircling the designated block B6 are multiple shot areas 11, 12, 13, 14, 15, 23, 27, 28, 29 and 30.

Multiple alignment marks selected from those in the multiple shot areas 19, 20, 21 and 22 that constitute the designated block B6 and those in the multiple shot areas 11, 12, 13, 14, 15, 23, 27, 28, 29 and 30 adjoining to and encircling that designated block B6 are used to measure and figure out the expansion and contraction of the substrate, so that shot block correction measurement data P_{B6} corresponding to the block B6 are obtained.

The obtained shot block correction measurement data P_{B6} are fed back to the shots for the shot areas 19, 20, 21 and 22 that constitute the associated block area B6, respectively, to determine the ratio ε₆ of optical expansion and contraction of a one shot of exposure area. At that ratio ε₆, all the shots in the block area B6 are exposed to complete the shot exposure for the block area B6.

### (Regarding the Block B7)

The designated block B7 is built up of shot areas 23, 24, 25 and 26. Shot areas adjoining to and encircling the designated block B7 are multiple shot areas 14, 15, 16, 17, 18, 22, 29, 30, 31 and 32.

Multiple alignment marks selected from those in the multiple shot areas 23, 24, 25 and 26 that constitute the designated block B6 and those in the multiple shot areas 14, 15, 16, 17, 18, 22, 29, 30, 31 and 32 adjoining to and encircling that designated block B7 are used to measure and figure out the expansion and contraction of the substrate, so that shot block correction measurement data P_{B7} corresponding to the block B7 are obtained.

The obtained shot block correction measurement data P_{B7} are fed back to the shots for the shot areas 23, 24, and 26 that constitute the associated block area B7, respectively, to determine the ratio ε₇ of optical expansion and contraction of a one shot of exposure area. At that ratio ε₇, all the shots in the block area B7 are exposed to complete the shot exposure for the block area B7.

### (Regarding the Block B8)

The designated block B8 is built up of shot areas 27, 28 and 29. Shot areas adjoining to and encircling the designated block B8 are multiple shot areas 19, 20, 21, 22, 23, 30, 33, 34 and 35.

Multiple alignment marks selected from those in the multiple shot areas 27, 28 and 29 that constitute the designated block B8 and those in the multiple shot areas 19, 20, 21, 22, 23, 30, 33, 34 and 35 adjoining to and encircling that designated block B8 are used to measure and figure out the expansion and contraction of the substrate, so that shot block correction measurement data P_{B8} corresponding to the block B8 are obtained.

The obtained shot block correction measurement data P_{B8} are fed back to the shots for the shot areas 27, 28 and 29 that constitute the associated block area B8, respectively, to determine the ratio ε₈ of optical expansion and contraction of a one shot of exposure area. At that ratio ε₈, all the shots in the block area B8 are exposed to complete the shot exposure for the block area B8.

### (Regarding the Block B9)

The designated block B9 is built up of shot areas 30, 31 and 32. Shot areas adjoining to and encircling the designated block B9 are multiple shot areas 22, 23, 24, 25, 26, 29, 34, 35 and 36.

Multiple alignment marks selected from those in the multiple shot areas 30, 31 and 32 that constitute the designated block B9 and those in the multiple shot areas 22, 23, 24, 25, 26, 29, 34, 35 and 36 adjoining to and encircling that designated block B9 are used to measure and figure out the expansion and contraction of the substrate, so that shot block correction measurement data P_{B9} corresponding to the block B9 are obtained.

The obtained shot block correction measurement data P_{B9} are fed back to the shots for the shot areas 30, 31 and 32 that constitute the associated block area B9, respectively, to determine the ratio ε₉ of optical expansion and contraction of a one shot of exposure area. At that ratio ε₉, all the shots in the block area B9 are exposed to complete the shot exposure for the block area B9.

### (Regarding the Block B10)

The designated block B10 is built up of shot areas 33, 34, 35 and 36. Shot areas adjoining to and encircling the designated block B10 are multiple shot areas 27, 28, 29, 30, 31 and 32.

Multiple alignment marks selected from those in the multiple shot areas 33, 34, 35 and 36 that constitute the designated block B10 and those in the multiple shot areas 27, 28, 29, 30, 31 and 32 adjoining to and encircling that designated block B10 are used to measure and figure out the expansion and contraction of the substrate, so that shot block correction measurement data P_{B10} corresponding to the block B10 are obtained.

The obtained shot block correction measurement data P_{B10} are fed back to the shots for the shot areas 30, 31 and 32 that constitute the associated block area B10, respectively, to determine the ratio ε₁₀ of optical expansion and contraction of a one shot of exposure area. At that ratio ε₁₀, all the shots in the block area B10 are exposed to complete the shot exposure for the block area B10.

### EXAMPLE

The present invention is now explained in greater detail with reference to some specific examples.

With the block B4 of FIG. 1 as an experimental area, there was experimentation carried out, in which exposure was done while the alignment precision of that block B4 was enhanced.

### (Preparatory Arrangements for Experimentation)

First of all, there was an AlTiC substrate of 6 inches φ in size and 2 mm in thickness provided.

The aligner used was NSR-EX14DTFH available from Nikon Co., Ltd.

The alignment mark used was one designated by Nikon Co., Ltd.

The alignment meter used was 5107 available from KLA Co., Ltd.

Using the box-in-box pattern specified by KLA Co., Ltd. as an alignment measurement mark, precision was checked. To find specific alignment precision, five box-in-box patterns were used per shot. For instance, referring now to the shot area 11 of FIG. 2, one basic box pattern (indicated by numeral 110) was formed at the center of the shot area 11, and four (indicated by numeral 111) were formed at the four corners of the shot area 11, five basic box patterns in all. To be more specific, a resist mask was printed by the 1^{st} exposure on a 100-nm thick titanium thin film to form a resist mask. Using this resist mask, the titanium thin film was etched by RIE (reactive ion beam etching) to form within each shot area a total of five basic boxes (of 26 μm×26 μm in size): one at the center and four at the four corners (see FIG. 2).

Then, the substrate was heated at 250% for 3 hours, and then cooled down to room temperature. This heating-and-cooling operation was repeated ten times for intentional application of thermal stress to the substrate.

### Comparative Example 1

After the completion of the aforesaid preparatory arrangements for experimentation, all 36 crisscross alignment marks 70 lying in the shot areas 1-36 in all the blocks B1-B10 were used to measure and figure out the expansion and contraction of the substrate thereby obtaining shot block correction measurement data Pₐᵥ throughout the substrate.

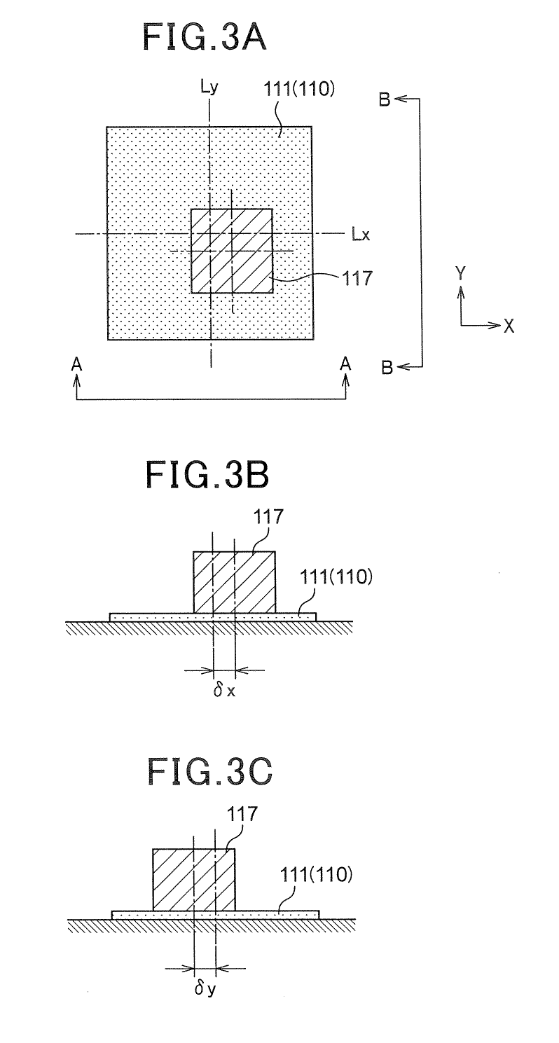

The obtained shot block correction measurement data Pₐᵥ were fed back to the shots for the shot areas 11, 12, 13 and 14 constituting the block area B4, respectively, to determine the ratio of optical expansion and contraction of a one shot of exposure area. At that ratio, the second exposure was implemented, homing in on the centers of the five basic boxes lying at all the shot areas in the block area B4, to form a micro-resist layer 117 of 13 μm×13 μm in size on the basic box 111 (110) (see FIG. 3). In FIG. 2, the as-formed micro-resist layer 117 is illustrated in the shot areas 11, 12, 13 and 14 of FIG. 2.

As shown in FIG. 3A, suppose here that basic axes are defined by the center axes Ly and Lx of the basic box 111 (110), as viewed from a plane. Then, alignment precision (3σ) was found by measuring offsets δx (see FIG. 3B) and δy (see FIG. 3C) from the basic axes in the X and Y directions, respectively.

Consequently, the alignment precision at the block B4 was 55 nm in the X direction and 53 nm in the Y direction.

It should be here noted that in the state of the substrate with no thermal stress applied on it, the alignment precision at the block B4 was 26 nm in the X direction and 27 nm in the Y direction, as measured in the aforesaid way. Given no anisotropic deformation of the substrate caused by the repeated heating-and-cooling operation, some fair alignment precision would be obtained even with the prior art. In any case, the aligner was adjusted such that its alignment offset was zero both in the X and Y directions.

### Example 1

After the completion of the aforesaid preparatory arrangements for experimentation, four alignment marks lying at the shot areas 11, 12, 13 and 14 in the block B4 were used to measure and figure out the expansion and contraction of the substrate thereby obtaining shot block correction measurement data P_{B4} corresponding to the block B4. The obtained shot block correction measurement data P_{B4} were fed back to the shots for the shot areas 11, 12, 13 and 14 constituting the block area B4, respectively, to determine the ratio of optical expansion and contraction of a one shot of exposure area. At that ratio, the second exposure was implemented, homing in on the centers of the basic boxes lying at all the shot areas in the block area B4, to form a micro-resist layer 117 on the basic box 111 (110) (see FIG. 3).

As shown in FIG. 3A, suppose here that basic axes are defined by the center axes Ly and Lx of the basic box 111 (110), as viewed from a plane. Then, alignment precision (3σ) was found by measuring offsets δx (see FIG. 3B) and δy (see FIG. 3C) from the basic axes in the X and Y directions, respectively.

Consequently, the alignment precision was 29 nm in the X direction and 61 nm in the Y direction. Although there was a less-than-satisfactory correction in the Y direction due to the use of only the alignment marks lying in the block B4, there was a satisfactory correction in the X direction, which was thought of as practicable.

### Example 2

A total of eight alignment marks: four in the shot areas 11, 12, 13 and 14 and four in the shot areas 19, 20, 21 and 22 adjoining to and encircling the block B4 were used to find alignment precision (3σ) according to the method of Example 1.

Consequently, the alignment precision was 28 nm in the X direction and 29 nm in the Y direction, meaning that the method was capable of following reliably the anisotropic deformation of the substrate by expansion and contraction and there was an excellent alignment precision achieved.

### Example 3

Seven alignment marks lying in the shot areas 5, 6, 7, 19, 20, 21 and 22 adjoining to and encircling the block B4 were used to find alignment precision (3σ) according to the method of Example 1.

Consequently, the alignment precision was 31 nm in the X direction and 30 nm in the Y direction, meaning that the method was capable of following reliably the anisotropic deformation of the substrate by expansion and contraction and there was an excellent alignment precision achieved.

### Example 4

A total of four alignment marks: two in the shot areas 12 and 14 in the block B4 and two in the shot areas 6 and 20 adjoining to and encircling the block B4 were used to find alignment precision (3σ) according to the method of Example 1.

Consequently, the alignment precision was 32 nm in the X direction and 31 nm in the Y direction, meaning that the method was capable of following reliably the anisotropic deformation of the substrate by expansion and contraction and there was an excellent alignment precision achieved.

### Example 5

A total of six alignment marks: four in the shot areas 11, 12, 13 and 14 in the block B4 and two in the shot areas 6 and 21 adjoining to and encircling the block B4 were used to find alignment precision (3σ) according to the method of Example 1.

Consequently, the alignment precision was 29 nm in the X direction and 29 nm in the Y direction, meaning that the method was capable of following reliably the anisotropic deformation of the substrate by expansion and contraction and there was an excellent alignment precision achieved.

The advantages of the invention could be appreciated from the aforesaid results of experimentation. That is, the present invention provides an alignment method for applying a one layer of shot exposure on and throughout a substrate, wherein a shot exposure area throughout the substrate is divided into N block areas Bᵢ (i=1 to N), each having multiple one-shot areas joined to one another in an adjoining state; N shot block correction measurement data P_{Bi} (i=1 to N) are found for each of the N block areas Bᵢ (i=1 to N); each of the N shot block correction measurement data P_{Bi} (i=1 to N) is fed back to an associated shot for the N block area Bᵢ (i=1 to N) to determine a ratio εᵢ (i=1 to N) of optical expansion and contraction of an exposure area for one shot per block; and at said ratio εᵢ (i=1 to N), all shots for each associated block are exposed to complete the one layer of shot exposure throughout the substrate, wherein said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas constituting said designated block B1 (i=1 to N) and alignment marks in multiple shot areas adjoining to and encircling said designated block Bᵢ (i=1 to N). Thus, even when the expansion and contraction of the substrate based on temperature changes or stress changes is anisotropic throughout the substrate, the method of the invention can reliably follow the deformation of the substrate, making sure the optimum alignment operation with improved precision. It is also possible to satisfy the requirements for a fabrication process involving post-integration processing after the substrate is cut into multiple blocks.

What is claimed is:

1. An alignment method for applying a one layer of shot exposure on and throughout a substrate, characterized in that:
a shot exposure area throughout the substrate is divided into N block areas Bᵢ (i=1 to N), each having multiple one-shot areas joined to one another in an adjoining state,
N shot block correction measurement data P_{Bi} (i=1 to N) are found for each of the N block areas Bᵢ (i=1 to N),
each of the N shot block correction measurement data P_{Bi} (i=1 to N) is fed back to an associated shot for the N block area Bᵢ (i=1 to N) to determine a ratio εᵢ (i=1 to N) of optical expansion and contraction of an exposure area for one shot per block, and
at said ratio εᵢ (i=1 to N), all shots for each associated block are exposed to complete the one layer of shot exposure throughout the substrate, wherein:
said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas constituting said designated block Bᵢ (i=1 to N) and alignment marks in multiple shot areas adjoining to and encircling said designated block Bᵢ (i=1 to N).

2. The alignment method according to claim 1, wherein said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas constituting said designated block Bᵢ (i=1 to N).

3. The alignment method according to claim 1, wherein said shot block correction measurement data P_{Bi} (i=1 to N) are obtained by measuring and figuring out an expansion and contraction of the substrate with respect to a designated block Bᵢ (i=1 to N) designated for shotting, using multiple alignment marks selected from alignment marks in multiple shot areas adjoining to and encircling said designated block.

4. The alignment method according to claim 1, wherein when said shot block correction measurement data are found, a number of the shot areas to be selected is at least 2 with respect to a total of shot areas in the designated block.

5. The alignment method according to claim 1, wherein said one-shot area is an area exposed in one single exposure operation.

6. The alignment method according to claim 1, wherein said substrate is a sintered substrate obtained by compression molding and then sintering fine particles of an inorganic material.

7. The alignment method according to claim 1, wherein said substrate is a semiconductor substrate.
